(19) United States
(12) Patent Application Publication
(10) Pub. No.: US 2013/0318800 A1
(43) Pub. Date: Dec. 5, 2013

(54) SINGLE-HANDED, ELECTRIC RING CUTTER

(71) Applicants: Ronald D. Weiss, Nashua, NH (US); Wesley I. Ripa, Durham, NH (US); Malcolm J. Paradise, Merrimack, NH (US)

(72) Inventors: Ronald D. Weiss, Nashua, NH (US); Wesley I. Ripa, Durham, NH (US); Malcolm J. Paradise, Merrimack, NH (US)

(21) Appl. No.: 13/487,821

(22) Filed: Jun. 4, 2012

(51) Int. Cl. B23D 45/16; B25B 27/14

(52) U.S. Cl. 30/370; 29/239

(57) ABSTRACT

A ring cutting device for cutting a ring lodged on a human finger and a device for separating and extracting a cut ring that is still on a wearer's finger. The ring cutting device can be operated by a single hand and includes an elongate power and drive portion that fits comfortable in a user's hand, a finger guard portion having a ring guard and a biasing system, a housing having a protective shield and a mount for mounting the finger guard portion, and a cutting portion having a rotatable circular saw blade that is mechanically coupled to the rotary drive mechanism of the power and drive portion. The power and drive portion includes a rotary drive mechanism that is mechanically coupled to a rotary drive motor the power and a light source for illuminating the ring during a cutting operation. The biasing system is mechanically coupled to the ring guard which includes a notched area for seating the ring before cutting and is disposed orthogonal or substantially orthogonal with respect to the longitudinal axis of the power and drive portion. Rotation of the circular saw blade is about the longitudinal axis of the power and drive portion.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

A tool for cutting a ring to remove it from a finger is often necessary, e.g., under emergency circumstances, or when the ring finger is swollen, inflamed, or otherwise injured. Referring to FIG. 1, U.S. Pat. No. 4,864,730 discloses a first-generation electric-powered ring cutting tool 10 for removing a ring from a finger. The cutting tool includes a rotatable saw blade 22, a high speed electrical drive motor 20 for driving the saw blade 22, a starting capacitor 25 for selectively starting the drive motor 20, and a pivoting lever arm 30, all of which are contained in or coupled to an elongate housing 10.

The lever arm 30 is pivotably attached to the housing 10 at a pivot point 31, which separates the lever arm 30 into a first, butted end 32, which has a thumb seat 35 and a second, indented end 33, which contains a squared notch 34 that is structured and arranged to support the ring and to maintain the ring in a steady position during the cutting operation. In operation, a user's thumb applies pressure to the thumb seat 35 at the butted end 32 of the pivoting lever arm 30, causing the butted end 32 to translate and engage a switch arm 14 to activate the motor 20. Application of downward pressure to the first, butted end 32 further causes the indented end 33 to rotate generally about the pivot point 31 upward toward the saw blade 22. The indented end 33 provides a stand-off distance between the saw blade 22 and the finger when the saw blade 22 is cutting through the ring.

As shown in FIG. 1, the axis of rotation 29 of the drive shaft 23 of the saw blade 22 and the drive motor 20 are perpendicular or substantially perpendicular to the longitudinal axis 15 of the housing 10 such that the direction of the cut is parallel or substantially parallel to the longitudinal axis 15 of the housing 10. The direction of rotation of the indented end 33 of the lever arm 30 is also parallel or substantially parallel to the longitudinal axis 15 of the housing 10.

An improved method of ring cutting, an ergonomic ring cutting device, a ring cutting device that is faster and safer, and the desire for greater operating safety has necessitated a second generation electric ring cutting tool.

### SUMMARY OF THE INVENTION

A ring cutting device for cutting a ring lodged on a human finger is disclosed. The device includes an elongate power and drive portion that fits comfortable in a user's hand, a finger guard portion having an L-shaped ring guard and a biasing system, a base portion having a protective shield and a mount for mounting the finger guard portion, and a cutting portion having a rotatable circular saw blade that is mechanically coupled to the rotary drive mechanism of the power and drive portion. The power and drive portion includes a rotary drive mechanism that is mechanically coupled to a rotary drive motor and an optional light source for illuminating the ring and work area during a cutting operation.

The biasing system is mechanically coupled to the base portion to self-adjust the ring guard portion. The ring guard, which is disposed orthogonal or substantially orthogonal with respect to the longitudinal axis of the power and drive portion, includes a notched area for seating the ring before cutting. Rotation of the circular saw blade is about the longitudinal axis of the power and drive portion.

### BRIEF DESCRIPTION OF THE SEVERAL VIEWS OF THE DRAWINGS

Other features and advantages of the invention will be apparent from the following description of the preferred embodiments thereof and from the claims, taken in conjunction with the accompanying drawings, in which:

FIG. 1 shows a schematic of an electric ring cutting device in accordance with the prior art;

FIG. 2 shows a schematic of an electric ring cutting device in accordance with the present invention;

FIG. 3 shows an exploded schematic view of the electric ring cutting device of FIG. 2;

FIG. 4 shows a detail of the self-adjusting design of the ring guard portion;

FIG. 5A shows an isometric view of an embodiment of a separation and extraction device;

FIG. 5B shows an end-on view of the embodiment of a separation and extraction device shown in FIG. 5A;

FIG. 5C shows a plan view of the embodiment of a separation and extraction device shown in FIG. 5A;

FIG. 6A shows an isometric view of a first embodiment of an end element for the separation and extraction device of FIG. 5A;

FIG. 6B shows an isometric view of a second embodiment of an end element for the separation and extraction device of FIG. 5A; and

FIG. 7 shows a plan view of another an embodiment of a separation and extraction device.

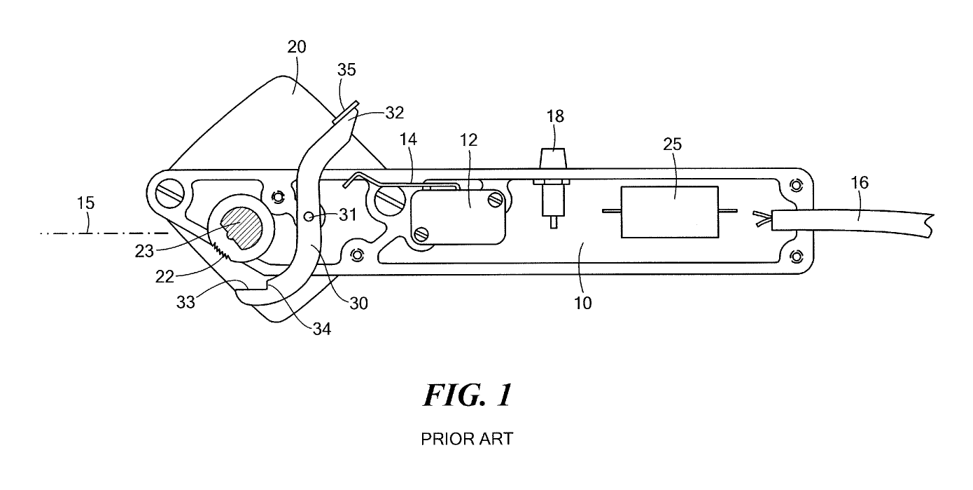

### DETAILED DESCRIPTION OF THE INVENTION

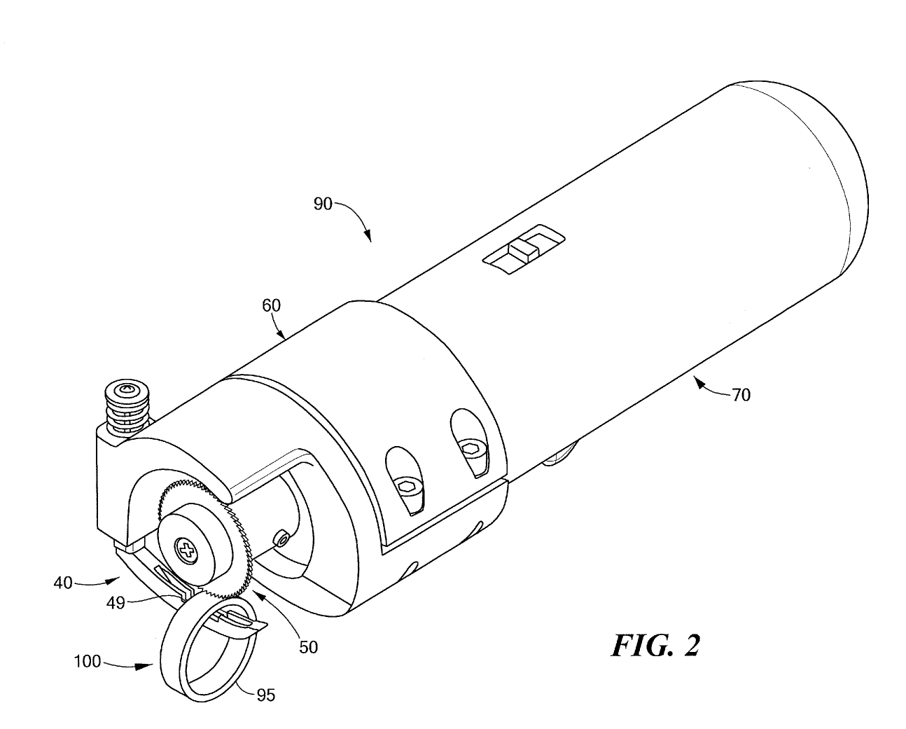

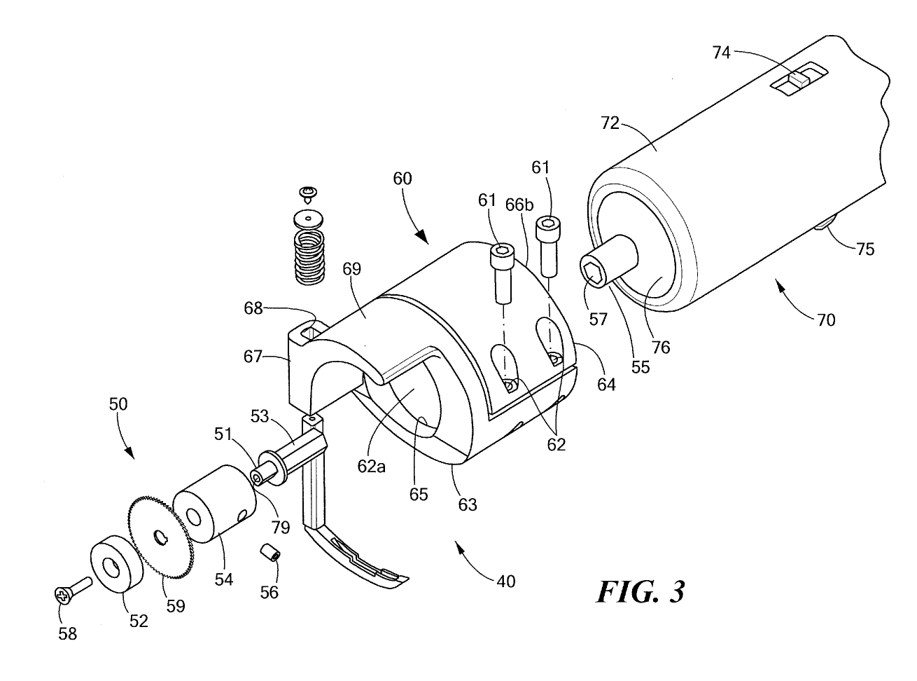

Referring to FIG. 2 and FIG. 3 a single-handed electric-powered ring cutting device 90 is shown. The device 90 includes a finger guard portion 40, a cutting portion 50, a base portion 60, and a power and drive portion 70.

The power and drive portion 70 is an elongate, cylindrically-shaped or substantially cylindrically-shaped device that is designed to be held in and operated using a single hand. The power and drive portion 70 is structured and arranged to accommodate a bi-directional electric drive motor (not shown), e.g., a rotary motor, and a power source, e.g., at least one removable and/or rechargeable battery (not shown), an AC power outlet cord (not shown), and the like, within its cylindrical body 72.

At a proximal end of the power and drive portion 70 is a rotating drive mechanism 55, e.g., a rotor shaft, that includes a center opening 57 for attaching the cutting portion 50 to the rotating drive mechanism 55. In a first embodiment, the rotating drive mechanism 55 and center opening 57 constitute a conventional hex-drive component. The rotating drive mechanism 55 can be cylindrical or substantially cylindrical in shape and is mechanically coupled to the rotary drive motor.

Also at the proximal end of the power and drive portion 70 is an optional light source 76, e.g., a light bulb, a light-emitting diode (LED), and the like, for the purpose of illuminating the cutting area when the cutting portion 50 is in operation. The light source 76 is adapted to automatically turn ON when the rotating drive mechanism 55 is operating and to turn OFF when the rotating drive mechanism 55 is not operating. Optionally, a selector switch (not shown) can be provided on the cylindrical body 72 to turn ON/OFF the light source 76.

A power (ON/OFF) button 74 is provided on the outer surface of the cylindrical body 72. The ON/OFF button 74 is a selector switch that, when turned ON, delivers power to the rotary drive motor and to the light source 76 selectively. A drive direction switch 75 is also provided and adapted to operate the rotary drive motor selectively in a forward (clockwise) direction or a reverse (counter-clockwise) direction. Prior art devices typically have mechanically blocked the blade operating from in a reverse direction. However, enabling the blade to operate in a reverse direction facilitates clearing blade jams.

The base portion 60 includes a first housing portion 63 and second housing portion 64, which can be releasably attached to each other using a plurality of fastening devices 61, e.g., screws, bolts, and the like, that are disposed through a corresponding plurality of openings 62 provided for that purpose. When the first housing portion 63 and second housing portion 64 are mated, the inner surface 65 of the hollow base portion 60 has a substantially cylindrical shape having openings 66a and 66b at both ends. The inner diameter of the base portion 60 is slightly smaller than the outer diameter of the power and drive portion 70 so that when the power and drive portion 70 is inserted between the two housing portion 63 and 64 and the fastening devices 61 are tightened, the base portion 60 forms a tight, interference fit with the power and drive portion 70.

The rear opening 66b is sized to accommodate the power and drive portion 70 while the front opening 66a is sized to accommodate the rotating drive mechanism 55 and, moreover, to allow light from the light source 76 to pass through the front opening 66a, to illuminate the finger guard 40 and the cutting portions 50 during a cutting operation.

The base portion 60 includes a protective blade shield 69 that is disposed at the forward end of the base portion 60 and that is integrated into the second housing portion 64. The protective blade shield 69 provides some protection against harm that can be caused by a rotating saw blade 59. The base portion 60 also includes a mount 67 that is integrated into or onto the protective blade shield 69. The mount 67 is structured and arranged to accommodate the ring guard portion 40. More specifically, the mount 67 includes an opening 68 through which a portion of the ring guard portion 40 can translate freely.

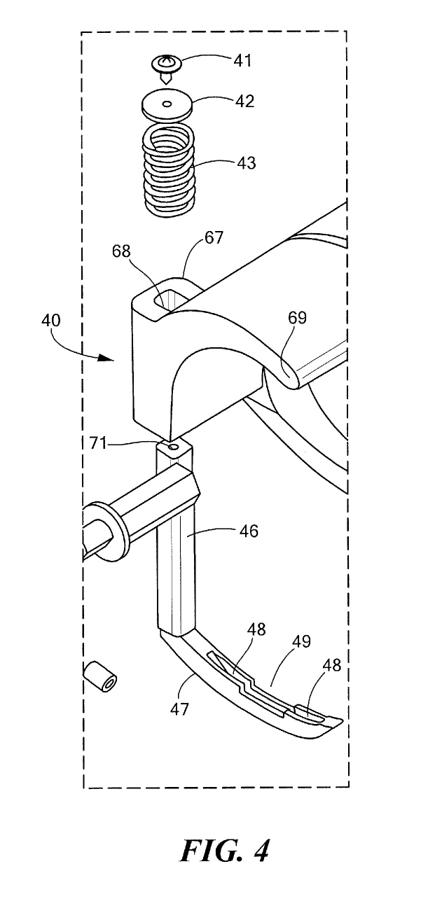

Referring to FIG. 4, a detail of the ring guard portion 40 is shown. The ring guard portion 40 includes an L-shaped or substantially L-shaped ring guard and a biasing device. The leg of the L-shaped ring guard is the ring guard 47 itself while the stem of the L-shaped ring guard is a translating portion 46. The translating portion 46 is adapted to fit into and to translate within the opening 68 in the mount 67 without resistance. An opening 71 at the top of the translating portion 46 is provided for releasably attaching the biasing portion to the top of the translating portion 46.

The biasing portion provides a generally upward biasing force to the ring guard portion 40 for the purpose of self-adjustment. For that purpose, the biasing portion includes a biasing spring 43, a reaction plate 42, and a fastening device 41. The outer diameter of the biasing spring 43 is greater than the greatest dimension of the opening 68 in the mount 67 but smaller than the outer diameter of the reaction plate 42. The inner diameter of the biasing spring 43 is greater than the outer diameter or outer periphery of the translating portion 46, to allow the translating portion 46 to translate along the longitudinal axis of and within the biasing spring 43.

The translating portion 46 is disposed within the opening 68 and within the biasing spring 43. The fastening device 41 is attached to the opening 71 in the translating portion 46 so that the reaction plate 42 and the biasing spring 43 are releasably attached to the same. When not in use, the biasing spring 43 biases the saw blade ring guard 47 so that the teeth, i.e., the outer peripheral surface, of the saw blade 59 are contained within the trough portion 48 of the ring guard 47. When the ring guard 47 is disposed between the annulus 95 of the ring 100 to be cut and the wearer's finger, the biasing spring 43 forces the annulus 95 of the ring 100 towards the saw blade 59.

The ring guard 47 of the L-shaped ring guard is fixedly attached to or permanently integrated into the distal end of the translating portion 46. The ring guard 47 includes a trough portion 48 that is sized to accommodate the least dimension, i.e., the thickness, of the saw blade 59. The ring guard 47 also includes a notched area 49 that is structured and arranged to accommodate and to provide some degree of confinement or seating to a ring 100.

The cutting portion 50 includes a rotable, circular saw blade 59, e.g., a standard saw blade, a diamond-coated blade, and the like, and means for releasably attaching the rotary saw blade 59 to the rotating drive mechanism 55 of the power and drive portion 70. Advantageously, the means for releasably attaching the rotary saw blade 59 to the rotating drive mechanism 55 are designed for ease of removal and replacement. When properly attached, the rotary saw blade 59 will be disposed immediately below the protective blade shield 69 and the least dimension of the saw blade 49 will be in registration with and seated in the trough portion 48 of the ring guard 47.

In addition to the saw blade 59, the cutting portion 50 includes a hex-drive connector pin 53, i.e., a hex insert, a cylindrical spacer 54, a cylindrical top portion 52, and a fastening device 58. A first end of the hex drive connector pin 53 is adapted to be inserted into the hex-drive opening 57 of the rotating drive mechanism 55 and to provide a tight, interference fit therewith. A second end of the connector pin 53 includes an elongate, D-shaped post 51 that is adapted to be inserted into and through an opening in the cylindrical spacer 54 and a D-shaped opening in the saw blade 59.

A locking device 56, e.g., a cylinder screw, is adapted to be inserted into a small opening on the peripheral face of the cylindrical spacer 54 and to exert a force against the flat face of the D-shaped post 51, to lock the cylindrical spacer 54 onto the connector pin 53. Furthermore, a fastening device 58, e.g., a screw, a bolt, and the like, is mechanically coupled to an opening 79 in the tip of the D-shaped post 51.

Although the ring cutting device 90 has been described assuming a single rotary saw blade, the invention is not to be construed as being limited thereto. For example, the ring cutting device 90 can include a multi-blade, e.g., a twin-blade, cutting portion 50. The twin-blade embodiment would include a pair of rotary saw blades 59 that are separated by a spacing washer (not shown). Such an embodiment would produce a wider cut through the ring, e.g., approximately ¼ inch but dependent on the thicknesses of the saw blades 59 and of the spacing washer.

Having described an electric ring cutting device, a method of cutting a ring from a finger will now be described. First, the ring guard 47 of the ring guard portion 40 is routed between the ring 100 to be removed and the wearer's finger. More particularly, the ring 100 is disposed within the notched portion 49 of the ring guard 47. Once the ring 100 is secured in the notched portion, the ON/OFF switch 75 of the power and drive portion 70 can be moved to the ON position, causing the saw blade(s) to rotate.

The biasing system keeps the ring 100 in contact with the rotating saw blade(s) 59. So that, as the saw blades 59 cut through the ring 100, the ring 100 is automatically biased against the saw blade(s) 59. Once the saw blade(s) 59 has passed through the ring 100 and contacts the trough portion 48 of the ring guard 47, the ON/OFF switch 75 of the power and drive portion 70 can be moved to the OFF position and the ring guard 47 of the ring guard portion 40 is extracted from between the ring 100 and the wearer's finger.

Once cut, some cut rings 100 can be removed by working the ring 100 off of the wearer's finger. Using a pair of rotating saw blades produces a wider cut, which would make it even easier to remove. The rotating saw blades in the pair would be separated by a spacer or washer or a pre-determined thickness, to provide the wider cut. In some instances, however, a separation and extraction device may be necessary.

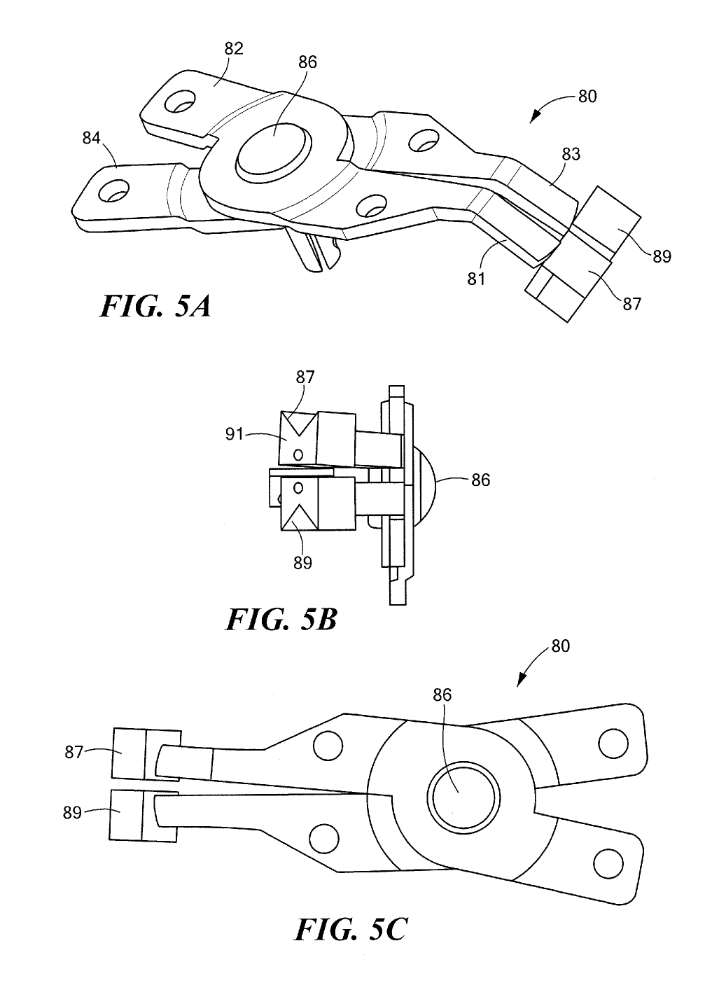

A first embodiment of a separation and extraction device 80 is shown in FIG. 5A to FIG. 5C. The device 80 resembles a pair of pliers, with a pair of gripping ends 82 and 84 rotatably coupled to each other at a pivot point 86. Optionally, a spring can be provided to bias the jaws 81 and 83 of the device 80 closed.

Distal from the pair of gripping ends 82 and 84 and on the other side of the pivot point 86 is a pair of pinching jaws 81 and 83 that are in contact with one another when the pair of gripping ends 82 and 84 are in a rest state as illustrated. Squeezing the gripping ends 82 and 84 together causes the gripping ends 82 and 84 to approach one another and the jaws 81 and 83 to separate and move apart from one another.

At the tip of each jaw 81 and 83 are corresponding end elements 89 and 87, which, collectively, are structured and arranged to fit between the gap in the annulus 95 of the cut ring 100. Each of the end elements 89 and 87 is adapted to retain one of the cut ends of the annulus 95 of the ring 100; so that, when force is applied to gripping ends 82 and 84 and the jaws 81 and 83 separate and move apart from one another, the end elements 89 and 87 force apart the retained ends of the annuls 95, making it easier to remove the ring 100 from the wearer's finger.

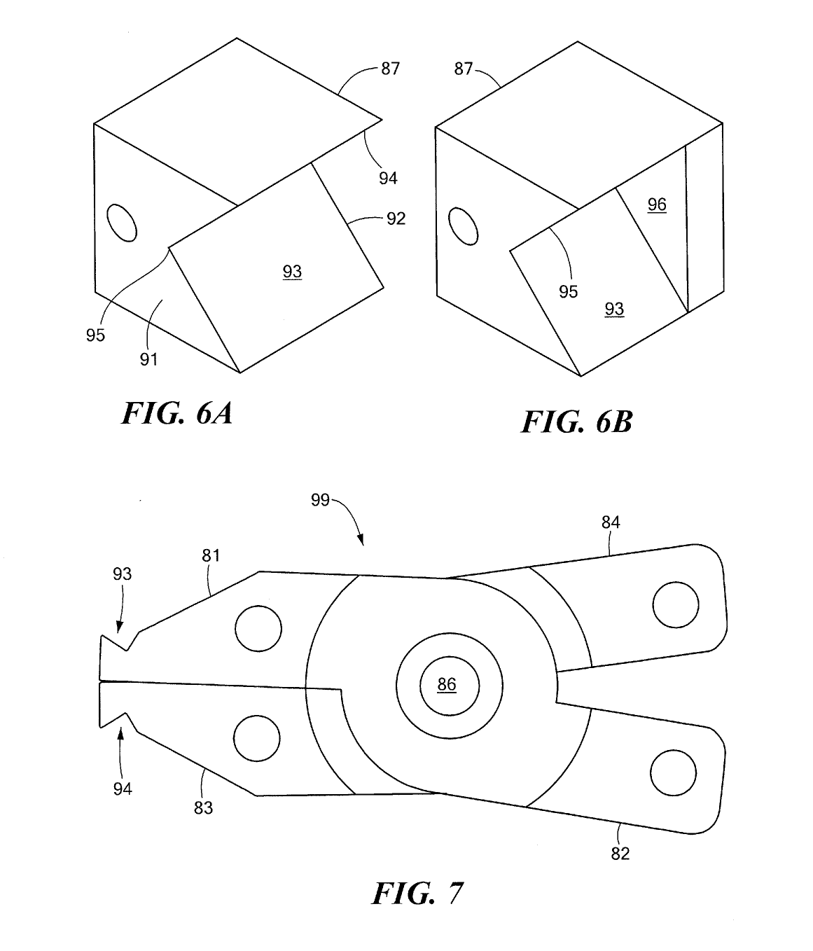

Referring to FIG. 6A, a first embodiment of an end element 87 is shown. Those of ordinary skill in the art can appreciate that the other end element 89 would be a reflection of the end element 87 shown in FIG. 6A. As previously mentioned, the end elements 87 and 89 are fixedly or removably attached to the jaws 83 and 81. The end element 87 includes a top portion 91 and a bottom portion 92 and a notched portion that includes notch faces 93 and 94, which meet at the notch 95. In operation, the end elements 87 and 89 are positioned so that the cut ends of the ring 100 are positioned against the notch faces 93 and 94 and when the gripping ends 82 and 84 are squeezed together, frictional contact between the notch faces and 94 and the cut ends of the ring 100 pulls the ends further apart.

Referring to FIG. 6B, a second embodiment of an end element 87 is shown. The second embodiment is similar to the first embodiment, further including a wall 96, which is structured and arranged to hold the ends of the ring 100.

Referring to FIG. 7, a third embodiment of a separation and extraction device 99 is shown. As with the first embodiment 80 described herein above, the device 99 resembles a pair of pliers, with a pair of gripping ends 82 and 84 rotatably coupled to each other at a pivot point 86. Distal from the pair of gripping ends 82 and 84 and on the other side of the pivot point 86 is a pair of pinching jaws 81 and 83 that are in contact with one another when the pair of gripping ends 82 and 84 are in a rest state as illustrated. Squeezing the gripping ends 82 and 84 together causes the gripping ends 82 and 84 to approach one another and the jaws 81 and 83 to separate and move apart from one another.

At the tip of each jaw 81 and 83 are corresponding V-shaped end elements 93 and 94, which, collectively, are structured and arranged to fit between the gap in the annulus 95 of the cut ring 100. Each of the end elements 93 and 94 is adapted to retain one of the cut ends of the annulus 95 of the ring 100; so that, when force is applied to gripping ends 82 and 84 and the jaws 81 and 83 separate and move apart from one another, the end elements 93 and 94 force apart the retained ends of the annuls 95, making it easier to remove the ring 100 from the wearer's finger.

Although preferred embodiments of the invention have been described above, it will be recognized and understood that various modifications may be made in the invention and that the appended claims are intended to cover all such modifications which fall within the spirit and scope of the invention.

What I claim is:

1. A ring cutting device for cutting a ring lodged on a human finger, the device comprising:
an elongate power and drive portion that fits in a user's hand, the power and drive portion including a rotary drive mechanism, the rotary drive mechanism being mechanically coupled to a rotary drive motor;
a finger guard portion having a ring guard and a biasing system, wherein the biasing system is mechanically coupled to the ring guard;
a housing having a protective shield and a mount for mounting the finger guard portion; and
a cutting portion having a rotatable circular saw blade that is mechanically coupled to the rotary drive mechanism of the power and drive portion.

2. The device as recited in claim 1, wherein the finger guard portion is an L-shaped finger guard:
a leg of which is the ring guard;
a stem of which is disposed through an opening in the mount of the housing; and
an end of which is releasably attached to the biasing system.

3. The device as recited in claim 2, wherein the leg of the ring guard includes a central trough area that is sized to accommodate a least dimension of the circular saw blade.

4. The device as recited in claim 1, wherein the ring guard of the finger guard portion includes a notched area for seating the ring before cutting.

5. The device as recited in claim 1, wherein the ring guard is disposed orthogonal or substantially orthogonal with respect to a longitudinal axis of the power and drive portion.

6. The device as recited in claim 1, wherein rotation of the circular saw blade is about a longitudinal axis of the power and drive portion.

7. The device as recited in claim 1, wherein the biasing system includes:
a reaction plate;
a biasing spring having a first end in contact with the reaction plate and a second, opposite end in contact with the mount of the housing; and
a fastening device that is releasably attached to an end of the ring guard.

8. The device as recited in claim 1, wherein the biasing system is structured and arranged to bias the ring towards the circular saw blade when the ring guard of the finger guard portion is disposed between the human finger and said ring.

9. The device as recited in claim 1, wherein the power and drive portion includes a light source for illuminating the ring during a cutting operation, the light source being electrically coupled to a power source.

10. The device as recited in claim 1, wherein the circular saw blade is a standard saw blade or a diamond-coated blade.

11. The device as recited in claim 1, wherein the circular saw blade includes a pair of saw blades that are separated by a spacing washer.

12. A device for separating and extracting a cut ring that is still on a wearer's finger, the device comprising:
a pair of gripping ends, each gripping end rotatably coupled to the other gripping end at a pivot point;
a pair of pinching jaws disposed at a distal end of a corresponding gripping end of the pair of gripping ends, each of the pinching jaws having an end element that is adapted to retain one end of the cut ring; and
a biasing spring that is adapted to bias each of the gripping ends against the other when at rest and to cause the pair of pinching jaws to separate when the pair of gripping ends is squeezed together.
